(19) United States
(12) Patent Application Publication
(10) Pub. No.: US 2021/0392676 A1
(43) Pub. Date: Dec. 16, 2021

(54) TERMINAL DEVICE AND BASE STATION DEVICE USED IN WIRELESS COMMUNICATION SYSTEM

(71) Applicant: FUJITSU LIMITED, Kawasaki-shi (JP)

(72) Inventors: Hiroaki SENOO, Kawasaki (JP); YOSHIHIRO KAWASAKI, Kawasaki (JP); Toshiro Sawamoto, Yokohama (JP)

(73) Assignee: FUJITSU LIMITED, Kawasaki-shi (JP)

(21) Appl. No.: 17/462,078

(22) Filed: Aug. 31, 2021

Related U.S. Application Data
(63) Continuation of application No. PCT/JP2019/012014, filed on Mar. 22, 2019.

(51) Int. Cl. H04W 72/14; H04W 72/10

(52) U.S. Cl. CPC H04W 72/14; H04W 72/10

(57) ABSTRACT

A terminal device has a processor and is used in a wireless communication system. The processor determines a value pertaining to a stop time of a transmission process. When the terminal device receives a first signal indicating a UL grant and then receives a second signal indicating an instruction to stop the uplink transmission, the processor counts an elapsed time since the reception of the second signal. The processor performs the uplink transmission based on the first signal when the terminal device receives a third signal indicating a restart of the uplink transmission before the elapsed time reaches the determined value. The processor performs the uplink transmission based on a grant indicated by a fourth signal when the terminal device receives the fourth signal after the elapsed time reaches the determined value, the fourth signal indicating a grant of the uplink transmission.

### CROSS-REFERENCE TO RELATED APPLICATION

This application is a continuation application of International Application PCT/JP2019/012014 filed on Mar. 22, 2019 and designated the U.S., the entire contents of which are incorporated herein by reference.

### FIELD

The embodiments discussed herein are related to a terminal device, a base station device, and a wireless communication system that includes the terminal device and the base station device.

### BACKGROUND

Communication standards for the fifth-generation mobile communication (5G (NR: New Radio)) need to attain techniques for implementing the standard techniques of the fourth-generation mobile communication (4G (LTE: Long Term Evolution)) (e.g., documents 1-12 below) as well as higher data rates, larger capacities, and lower latencies. The 3GPP working groups (e.g., TSG-RAN WG1, TSG-RAN WG2) have studied standards for the fifth-generation communication (e.g., documents 13-39 below).

### Document 1: 3GPP TS 36.133 V15.5.0 (2018-12)

### Document 2: 3GPP TS 36.211 V15.4.0 (2018-12)

### Document 3: 3GPP TS 36.212 V15.4.0 (2018-12)

### Document 4: 3GPP TS 36.213 V15.4.0 (2018-12)

### Document 5: 3GPP TS 36.300 V15.4.0 (2018-12)

### Document 6: 3GPP TS 36.321 V15.4.0 (2018-12)

### Document 7: 3GPP TS 36.322 V15.1.0 (2018-07)

### Document 8: 3GPP TS 36.323 V15.2.0 (2018-12)

### Document 9:3GPP TS 36.331 V15.4.0 (2018-12)

### Document 10: 3GPP TS 36.413 V15.4.0 (2018-12)

### Document 11: 3GPP TS 36.423 V15.4.0 (2018-12)

### Document 12: 3GPP TS 36.425 V15.0.0 (2018-06)

### Document 13: 3GPP TS 37.340 V15.4.0 (2018-12)

### Document 14: 3GPP TS 38.201 V15.0.0 (2017-12)

### Document 15: 3GPP TS 38.202 V15.4.0 (2018-12)

### Document 16: 3GPP TS 38.211 V15.4.0 (2018-12)

### Document 17: 3GPP TS 38.212 V15.4.0 (2018-12)

### Document 18: 3GPP TS 38.213 V15.4.0 (2018-12)

### Document 19: 3GPP TS 38.214 V15.4.0 (2018-12)

### Document 20: 3GPP TS 38.215 V15.4.0 (2018-12)

### Document 21: 3GPP TS 38.300 V15.4.0 (2018-12)

### Document 22: 3GPP TS 38.321 V15.4.0 (2018-12)

### Document 23: 3GPP TS 38.322 V15.4.0 (2018-12)

### Document 24: 3GPP TS 38.323 V15.4.0 (2018-12)

### Document 25: 3GPP TS 38.331 V15.4.0 (2018-12)

### Document 26: 3GPP TS 38.401 V15.4.0 (2018-12)

### Document 27: 3GPP TS 38.410 V15.2.0 (2018-12)

### Document 28: 3GPP TS 38.413 V15.2.0 (2018-12)

### Document 29: 3GPP TS 38.420 V15.2.0 (2018-12)

### Document 30: 3GPP TS 38.423 V15.2.0 (2018-12)

### Document 31: 3GPP TS 38.470 V15.4.0 (2018-12)

### Document 32: 3GPP TS 38.473 V15.4.1 (2019-01)

### Document 33: 3GPP TR 38.801 V14.0.0 (2017-03)

### Document 34: 3GPP TR 38.802 V14.2.0 (2017-09)

### Document 35: 3GPP TR 38.803 V14.2.0 (2017-09)

### Document 36: 3GPP TR 38.804 V14.0.0 (2017-03)

### Document 37: 3GPP TR 38.900 V15.0.0 (2018-06)

### Document 38: 3GPP TR 38.912 V15.0.0 (2018-06)

### Document 39: 3GPP TR 38.913 V15.0.0 (2018-06)

With respect to 5G, supports have been considered for use cases such as Enhanced Mobile Broadband (eMBB), Machine Type Communications (Massive MTC), and Ultra-Reliable and Low Latency Communication (URLLC) in order to address a wide variety of services.

It is not easy to implement URLLC among the use cases. For example, the required error rate is 10⁻⁵ in URLLC. In this regard, such ultra-high reliability may be attained by providing high data redundancy using more radio resources. However, since there are only limited radio resources, limitlessly increasing resources to be used is not preferable. In URLLC, a target value for latencies in the uplink and downlink of a user plane is 0.5 milliseconds. This target value is no greater than 1/10 of that in LTE. Thus, URLLC is required to satisfy both ultra-high reliability and low latency.

In 5G, URLLC data and non-URLLC data (e.g., eMBB data) need to be concurrently supported on the same carrier frequency. In this regard, as described above, URLLC data needs to satisfy ultra-high reliability and low latency. Preemption has been studied as one scheme in which the processing of URLLC data is prioritized over the processing of non-URLLC data. In a wireless communication system in which preemption is performed, when URLLC data is generated and there are no radio resources that can be used to transmit the data at that moment or there is a shortage of such radio resources, some of or all of the radio resources that have already been allocated to other non-URLLC data are canceled and allocated to the URLLC data. In this way, start of a transmission of the URLLC data can be suppressed from being delayed. The transmission of the non-URLLC data that was supposed to be carried out using the radio resources is canceled, and interference between the URLLC data and the non-URLLC data is avoided so that a highly reliable transmission of the URLLC data can be attained.

A proposed technique is one wherein while a base station device is in communication with a terminal device for eMBB, data is transmitted to a terminal device for URLLC by using some of the radio resources already allocated to the terminal device for eMBB (e.g., Japanese Laid-open Patent Publication No. 2018-182358).

In a wireless communication system in which both terminal devices that transmit high-priority data (hereinafter, “high-priority terminals”) and terminal devices that transmit low-priority data (hereinafter, “low-priority terminals”) are implemented, priority control is performed for uplinks such that data transmissions from the high-priority terminals are prioritized. For example, when radio resources are allocated to a low-priority terminal, the low-priority terminal will start a coding process and a modulation process for transmission data. Assume that before the low-priority terminal performs the data transmission, a high-priority terminal has sent a scheduling request (resource allocation request) to a base station, and the radio resources that were allocated to the low-priority terminal are allocated to the high-priority terminal. In this case, the low-priority terminal stops the data transmission. Then, when the high-priority terminal finishes a data transmission, new radio resources will be allocated to the low-priority terminal. Subsequently, the low-priority terminal performs a coding process and a modulation process for the transmission data again. Thus, in this case, the low-priority terminal repeatedly performs a coding process and a modulation process for transmission data. Accordingly, a processing amount pertaining to a data transmission performed by a low-priority terminal may increase when priority control is performed for an uplink.

Such a problem may arise not only between a base station and terminal devices but also between any wireless devices.

### SUMMARY

According to an aspect of the embodiments, a terminal device is used in a wireless communication system that includes a base station. The terminal device includes a processor configured to determine a value pertaining to a stop time of a transmission process, count, when the terminal device receives a first signal indicating a grant of an uplink transmission from the base station and then receives a second signal indicating an instruction to stop the uplink transmission granted by the first signal from the base station, an elapsed time since the reception of the second signal, perform the uplink transmission based on the grant indicated by the first signal when the terminal device receives a third signal indicating a restart of the uplink transmission from the base station before the elapsed time reaches the determined value, and perform the uplink transmission based on a grant indicated by a fourth signal when the terminal device receives the fourth signal from the base station after the elapsed time reaches the determined value, the fourth signal indicating a grant of the uplink transmission.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a wireless communication system;

FIG. 2 illustrates an example of priority control for an uplink;

FIG. 3 illustrates another example of priority control for an uplink;

FIG. 4 illustrates an example of priority control for an uplink in a first embodiment;

FIG. 5 illustrates another example of priority control for an uplink in a first embodiment;

FIGS. 6A, 6B, 7A, 7B, 8A, 8B, 9A, and 9B illustrate methods for determining an acceptable pause time;

FIG. 10 is a flowchart illustrating an example of processes performed by a base station;

FIG. 11 is a flowchart illustrating an example of processes performed by a terminal device;

FIGS. 12A-12D illustrate examples of UL grants and transmission restart instructions;

FIG. 13 illustrates an example of a terminal device used in a first embodiment;

FIG. 14 illustrates an example of a base station used in a first embodiment;

FIG. 15 illustrates an example of priority control for an uplink in a second embodiment;

FIG. 16 illustrates another example of priority control for an uplink in a second embodiment;

FIG. 17 illustrates an example of a terminal device used in a second embodiment; and

FIG. 18 illustrates an example of a base station used in a second embodiment.

### DESCRIPTION OF EMBODIMENTS

The following describes embodiments of the present invention in detail by referring to the drawings. The problems and examples indicated herein are merely examples and do not limit the scope of right of the patent application. For example, the technology of the patent application may be applied to features described using different expressions, as long as such features are equivalent in technical respects. Embodiments described herein can be combined, as appropriate, as long as a contradiction does not arise.

Terms and technical features used herein may be those described in specifications (e.g., 3GPP TS 38.211 V15.2.0) or contributed articles as standards pertaining to communication, such as the 3GPP.

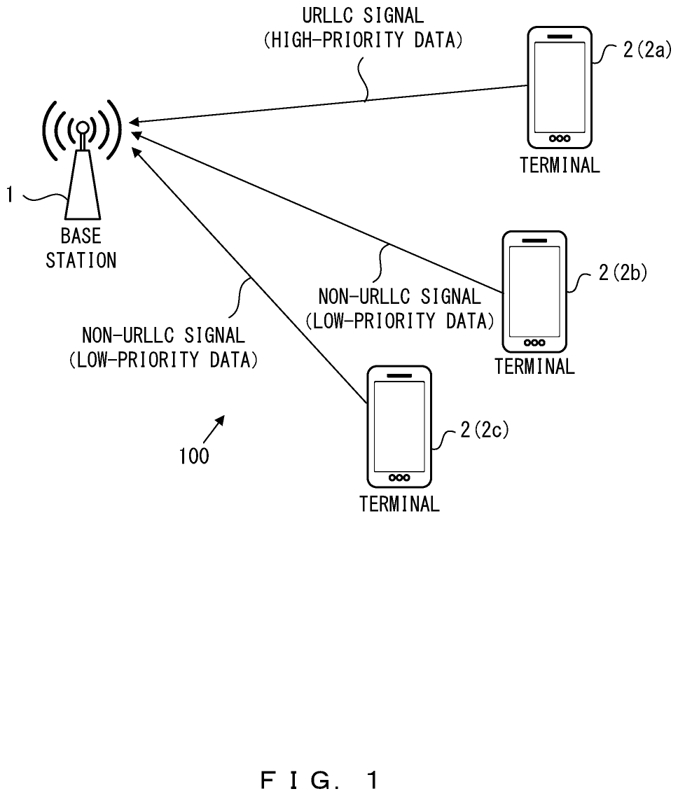

FIG. 1 illustrates an example of a wireless communication system in accordance with embodiments of the present invention. In this example, a wireless communication system 100 includes a base station device 1 and a plurality of terminal devices 2 (2a-2c). For example, the base station device 1 may be implemented by a next generation base station device (gNB: Next generation Node B). The base station device may hereinafter be referred to as the “base station.” The terminal device 2 may be implemented by user equipment (UE).

The base station 1 transmits a downlink signal to the terminal devices 2 located in a cell covered by the base station 1. Thus, each of the terminal devices 2 can receive a downlink signal transmitted from the base station 1. Each of the terminal devices 2 transmits an uplink signal to the base station 1. Thus, the base station 1 can receive uplink signals from the terminal devices 2 located in the cell.

In the example depicted in FIG. 1, the terminal device 2a supports URLLC communication. In this regard, URLLC data is required to attain high quality and low latency, so the priority of URLLC data is high. Thus, the terminal device 2a is an example of the high-priority terminal. However, the terminal device 2a may have a function for performing non-URLLC communication (e.g., eMBB communication). Meanwhile, the terminal devices 2b and 2c support non-URLLC communication. Thus, the terminal devices 2b and 2c are examples of the low-priority terminal. However, the terminal devices 2b and 2c may have a function for performing URLLC communication.

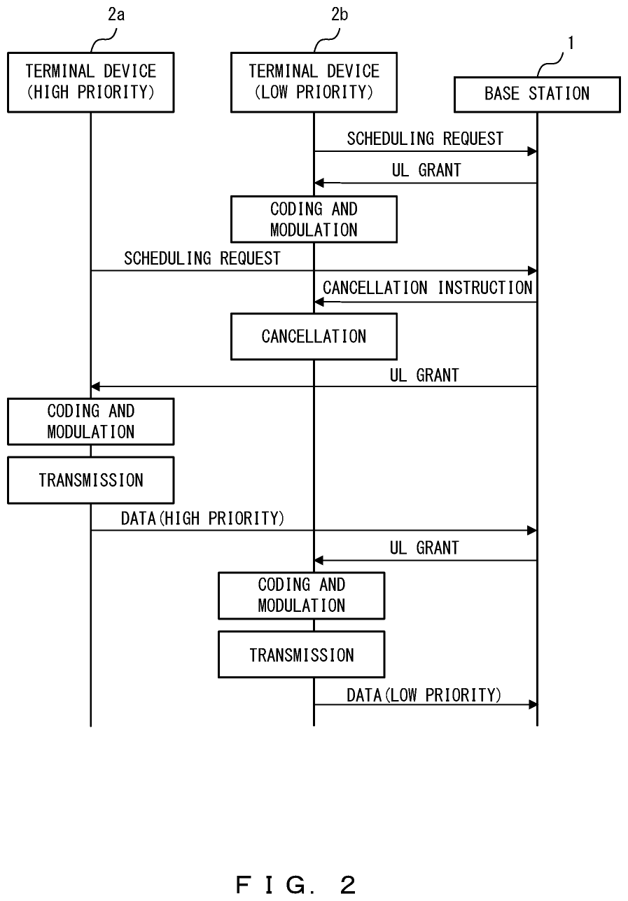

FIG. 2 illustrates an example of priority control for an uplink. In this example, the terminal devices 2a and 2b are connected to the base station 1. The terminal device 2a that transmits URLLC data (i.e., high-priority data) may hereinafter be referred to as a “high-priority terminal”). The terminal device 2b that transmits non-URLLC data (i.e., low-priority data) such as eMBB data may be referred to as a “low-priority terminal.”

When the terminal device 2b has generated low-priority data, the terminal device 2b transmits a scheduling request to the base station 1. Upon receipt of the scheduling request, the base station 1 determines a radio resource and an MCS (modulation and coding scheme) for transmitting the low-priority data and transmits an UL (uplink) grant to the terminal device 2b. The UL grant includes information indicating the radio resource and MCS for transmitting the low-priority data. The terminal device 2b performs a coding process and a modulation process in accordance with the UL grant so as to generate a data signal for carrying the low-priority data. The data signal is stored in a transmission buffer in the terminal device 2b. The data signal is generated as a result of the coding process and the modulation process.

Assume that the terminal device 2a has generated high-priority data before the terminal device 2b starts the data transmission. In this case, the terminal device 2a transmits a scheduling request to the base station 1. Upon receipt of the scheduling request, the base station 1 transmits a cancellation instruction to the terminal device 2b. Thus, the terminal device 2b performs a cancellation process. The cancellation process includes a process of discarding the data signal stored in the transmission buffer in the terminal device 2b. The base station 1 determines a radio resource and an MCS for transmitting the high-priority data and transmits an UL grant to the terminal device 2a. The UL grant includes information indicating the radio resource and MCS for transmitting the high-priority data.

The terminal device 2a performs a coding process and a modulation process in accordance with the UL grant so as to generate a data signal for carrying the high-priority data. The terminal device 2a outputs the data signal so as to transmit the high-priority data to the base station 1.

Upon receipt of the high-priority data from the terminal device 2a, the base station 1 determines a radio resource and an MCS for transmitting the low-priority data and transmits a new UL grant to the terminal device 2b. The terminal device 2b performs a coding process and a modulation process in accordance with the new UL grant so as to generate a data signal for carrying the low-priority data. The terminal device 2b outputs the data signal so as to transmit the low-priority data to the base station 1.

As described above, in the sequence depicted in FIG. 2, priority control for an uplink is implemented by giving a cancellation instruction to the terminal device 2b that transmits low-priority data. However, in this sequence, the terminal device 2b repeatedly performs a coding process and a modulation process. Thus, the processing amount pertaining to a data transmission performed by the terminal device 2b increases.

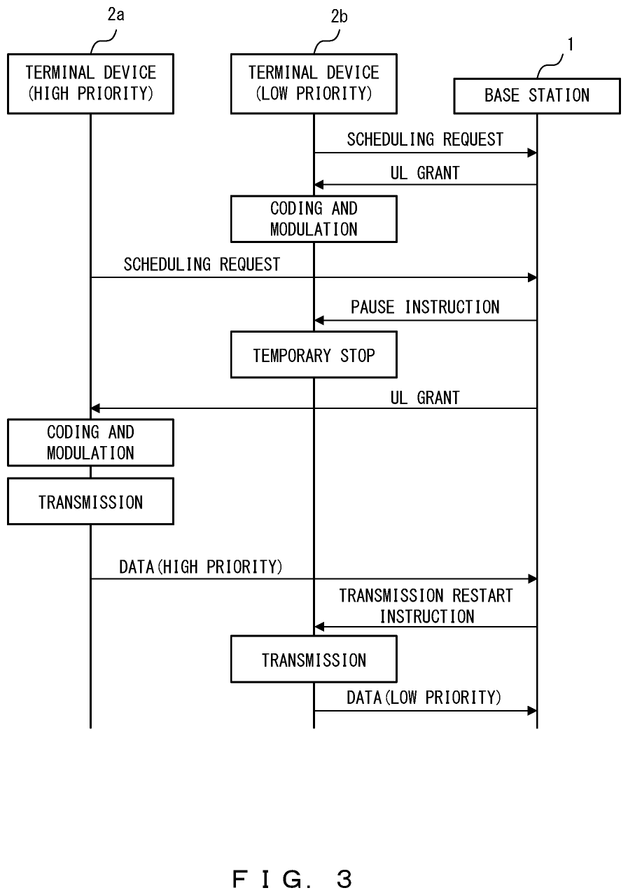

FIG. 3 illustrates another example of priority control for an uplink. In this example, as in the example depicted in FIG. 2, the terminal device 2b transmits, to the base station 1, a scheduling request for transmitting low-priority data, and then the terminal device 2a transmits, to the base station 1, a scheduling request for transmitting high-priority data.

Upon receipt of a scheduling request from the terminal device 2a, the base station 1 transmits a pause instruction to the terminal device 2b, instead of the cancellation instruction indicated in FIG. 2. Upon receipt of the pause instruction, the terminal device 2b temporarily stops a data transmission process. In this case, the terminal device 2b does not discard a data signal that has been generated and holds the data signal. Then, the terminal device 2a transmits high-priority data to the base station 1, as in the sequence depicted in FIG. 2.

Upon receipt of the high-priority data from the terminal device 2a, the base station 1 transmits a transmission restart instruction to the terminal device 2b. In response to this, the terminal device 2b outputs the data signal stored in the transmission buffer so as to transmit low-priority data to the base station 1.

As described above, in the sequence illustrated in FIG. 3, a pause instruction is given to the terminal device 2b instead of a cancellation instruction. Hence, in this sequence, the terminal device 2b does not need to repeatedly perform a coding process and a modulation process. However, in the case of a long pause period, the radio propagation environment between the terminal device 2b and the base station 1 attained when an MCS for transmitting low-priority data is determined may be different from the radio propagation environment between the terminal device 2b and the base station 1 attained when the terminal device 2b actually performs a data transmission. If the radio propagation environment significantly changes while the terminal device 2b stops a data transmission, the terminal device 2b will transmit data with an inappropriate MCS.

Assume, for example, that the radio propagation environment between the base station 1 and the terminal device 2b is good when the base station 1 receives a scheduling request from the terminal device 2b. In this case, a high modulation scheme (e.g., 256QAM) is reported to the terminal device 2b in order to attain a high transmission efficiency. Note that the modulation order indicates the number of bits carried by one symbol. Assume that afterwards, the radio propagation environment is degraded when a transmission restart instruction is given to the terminal device 2b. In this case, a data transmission is preferably performed with a low modulation scheme (e.g., 16QAM) in order to reduce a transmission error. However, in the sequence depicted in FIG. 3, the terminal device 2b transmits data with the initially reported modulation scheme (in this example, 256QAM). In this case, the base station 1 may be incapable of correctly receiving an uplink signal transmitted from the terminal device 2b. If there occurs such an amount of transmission error that recovery cannot be attained through error correction, a retransmission process will be performed, thereby increasing the processing amount pertaining to the data transmission performed by the terminal device 2b.

As described above, in the sequences depicted in FIGS. 2-3, the processing amount pertaining to the data transmission performed by a low-priority terminal may be large in the wireless communication system in which both high-priority terminals and low-priority terminals are implemented. The wireless communication system in accordance with embodiments of the present invention provides a function for solving or alleviating such a problem.

### First Embodiment

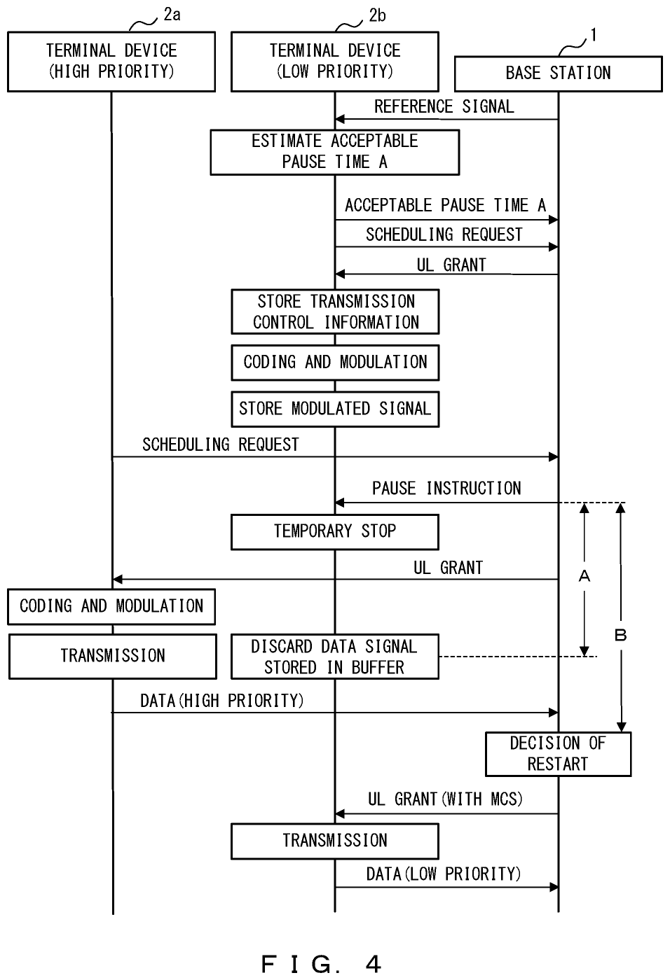

FIG. 4 illustrates an example of priority control for an uplink in a first embodiment. In the example depicted in FIG. 4, terminal devices 2a and 2b are connected to a base station 1. The terminal device 2a is a high-priority terminal that transmits URLLC data (i.e., high-priority data). The terminal device 2b is a low-priority terminal that transmits non-URLLC data such as eMBB data (i.e., low-priority data).

The base station 1 periodically transmits a downlink reference signal. The terminal device 2b estimates the acceptable pause time A according to the downlink reference signal. The acceptable pause time A indicates a period during which the terminal device 2b is to keep a data signal, i.e., the terminal device 2b is not to discard the data signal, when the terminal device 2b receives a pause instruction from the base station 1. The terminal device 2b reports the acceptable pause time A to the base station 1. The acceptable pause time A is an example of a “value pertaining to a stop time of a transmission process.” For example, the “value pertaining to a stop time of a transmission process” may be a period of time during which the terminal device 2b can hold the contents of transmission data in the memory in the terminal device since a start of temporary stop of transmission or a period of time during which a variation in a propagation path between the terminal device 2b and the base station can be considered to be sufficiently small since a start of temporary stop of transmission. Note that a method for estimating the acceptable pause time A will be described hereinafter in detail.

When the terminal device 2b has generated low-priority data, the terminal device 2b transmits a scheduling request to the base station 1. Upon receipt of the scheduling request, the base station 1 determines a radio resource and an MCS (modulation and coding scheme) for transmitting the low-priority data and transmits an UL grant to the terminal device 2b. The UL grant includes transmission control information for the terminal device 2b to transmit the low-priority data. The transmission control information includes information indicating the radio resource and MCS for transmitting the low-priority data. The information indicating a radio resource may also include information indicating a frequency and a time and information indicating a radio resource amount.

The terminal device 2b stores details of the UL grant (i.e., transmission control information) in the memory. The terminal device 2b performs a coding process and a modulation process in accordance with the UL grant so as to generate a data signal for carrying the low-priority data. The data signal is stored in the transmission buffer memory.

Assume that the terminal device 2a has generated high-priority data before the terminal device 2b starts the data transmission. In this case, the terminal device 2a transmits a scheduling request to the base station 1. Upon receipt of the scheduling request, the base station 1 transmits a pause instruction to the terminal device 2b. At this moment, the base station 1 starts to count an elapsed time since the transmission of the pause instruction.

Upon receipt of the pause instruction from the base station 1, the terminal device 2b temporarily stops the data transmission process. At this moment, the terminal device 2b starts to count an elapsed time since the reception of the pause instruction. When the terminal device 2b does not receive a transmission restart instruction from the base station 1 before the elapsed time since the reception of the pause instruction reaches the acceptable pause time A, the terminal device 2b will discard the data signal stored in the transmission buffer memory. In this case, the terminal device 2b may discard the transmission control information stored in the memory.

The base station 1 determines, according to the scheduling request received from the terminal device 2a, a radio resource and an MCS for transmitting the high-priority data and transmits an UL grant to the terminal device 2a. The UL grant includes information indicating the radio resource and MCS for transmitting the high-priority data. The terminal device 2a performs a coding process and a modulation process in accordance with the UL grant so as to generate a data signal for carrying the high-priority data. The terminal device 2a outputs the data signal so as to transmit the high-priority data to the base station 1.

Upon receipt of the high-priority data from the terminal device 2a, the base station 1 performs a transmission restart decision process. In particular, the base station 1 decides whether to restart the data transmission that has been stopped due to the pause instruction. In this example, the base station 1 decides whether to restart the data transmission performed by the terminal device 2b. In this case, the base station 1 compares the acceptable pause time A, which is reported from the terminal device 2b, with an elapsed time B from the transmission of the pause instruction to the present time. When the elapsed time B is shorter than the acceptable pause time A, the base station 1 restarts the data transmission performed by the terminal device 2b.

However, in the example depicted in FIG. 4, the elapsed time B is longer than the acceptable pause time A. In this case, the base station 1 newly generates transmission control information for the scheduling request initially received from the terminal device 2b. That is, new transmission control information is generated because the radio environment could have been changed due to the long elapsed time since the reception of the scheduling request by the base station 1. Then, the base station 1 transmits an UL grant including the new transmission control information to the terminal device 2b.

The terminal device 2b receives the UL grant including the new transmission control information. The terminal device 2b performs a coding process and a modulation process according to the new transmission control information so as to generate a data signal for carrying the low-priority data. Then, the terminal device 2b outputs the data signal so as to transmit the low-priority data to the base station 1.

As described above, when a transmission waiting time of the terminal device 2b that is caused by a pause instruction exceeds the acceptable pause time A, the base station 1 will generate new transmission control information. The terminal device 2b transmits low-priority data in accordance with the new transmission control information. Hence, the data transmission is performed with a radio resource, a coding scheme, and a modulation scheme that are suitable for the latest radio environment. As a result, efficient communication and/or communication with few transmission errors are/is implemented.

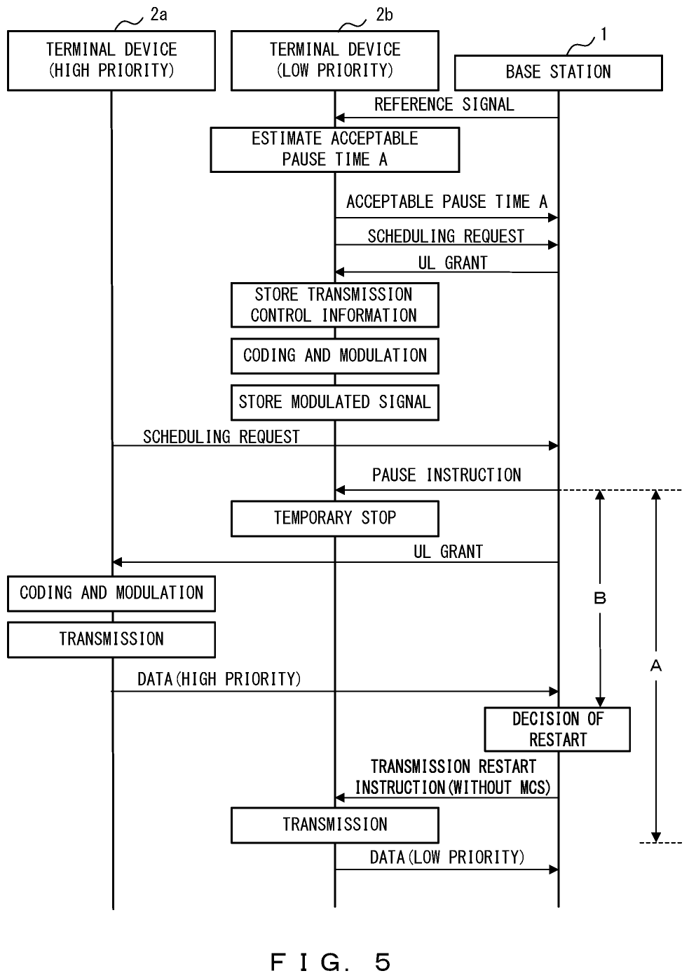

FIG. 5 illustrates another example of priority control for an uplink in the first embodiment. In this example, the base station 1 receives high-priority data from the terminal device 2a before an elapsed time since transmission of a pause instruction reaches the acceptable pause time A. That is, the elapsed time B is shorter than the acceptable pause time A. In this case, the base station 1 transmits a transmission restart instruction to the terminal device 2b. In the terminal device 2b, a data signal remains in the transmission buffer memory because the elapsed time since the reception of the pause instruction has not reached the acceptable pause time A. Transmission control information reported by a previous transmission grant also remains in the memory.

The transmission control information reported by the transmission restart instruction may lack a portion of the transmission control information reported by the UL grant. For example, the transmission control information reported by the UL grant includes information indicating a radio resource and information indicating an MCS. By contrast, the transmission control information reported by the transmission restart instruction does not include the information indicating an MCS. The transmission control information reported by the transmission restart instruction may not include the information indicating a radio resource.

Upon receipt of the transmission restart instruction from the base station 1, the terminal device 2b outputs the data signal stored in the transmission buffer memory so as to transmit low-priority data to the base station 1. In this case, the terminal device 2b does not need to perform a coding process and a modulation process.

As described above, when a transmission waiting time caused by a pause instruction is shorter than the acceptable pause time A, the terminal device 2b will transmit low-priority data according to initially reported transmission control information. In this regard, when a transmission waiting time is short, it is not considered that the radio environment has significantly changed since generation of initial transmission control information. Hence, the data transmission can be performed with a radio resource, a coding scheme, and a modulation scheme that are suitable for the current radio propagation environment, without acquiring new transmission control information. In addition, in the case depicted in FIG. 5, the terminal device 2b does not need to repeatedly perform a coding process and a modulation process. Accordingly, the processing amount pertaining to the data transmission performed by the terminal device 2b is reduced in comparison with the case depicted in FIG. 2.

The following describes a method for determining the acceptable pause time A. In the first embodiment, the terminal device 2b determines the acceptable pause time A.

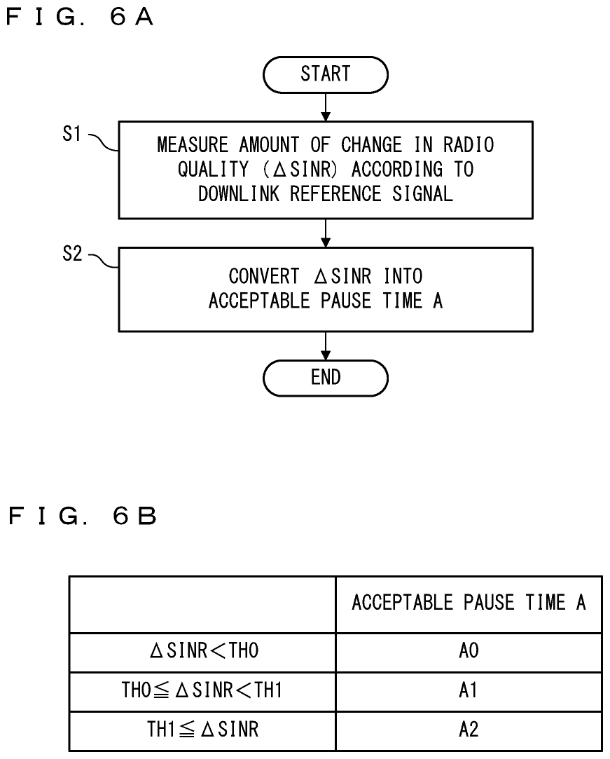

In the example depicted in FIGS. 6A and 6B, the terminal device 2b determines the acceptable pause time A according to a radio quality. In particular, in S1 in the flowchart depicted in FIG. 6A, the terminal device 2b measures an amount of change in a signal-to-interference plus noise ratio (SINR) according to a downlink reference signal received from the base station 1. The SINR is one of parameters indicating the radio quality. The amount of change in the SINR may hereinafter be referred to as “ΔSINR.” The SINR may be measured using a publicly known technique.

In S2, the terminal device 2b converts ΔSINR into the acceptable pause time A. In this example, ΔSINR is compared with specified thresholds TH0 and TH1, as depicted in FIG. 6B. “Acceptable pause time A=A0” is obtained when ΔSINR is smaller than the threshold TH0. “Acceptable pause time A=A1” is obtained when ΔSINR is larger than or equal to the threshold TH0 and smaller than the threshold TH1. “Acceptable pause time A=A2” is obtained when ΔSINR is larger than or equal to the threshold TH1. In this example, TH0<TH1 and A0>A1>A2 are satisfied. Thus, the smaller a change in the SINR is, the longer the acceptable pause time A is, and the larger a change in the SINR is, the shorter the acceptable pause time A is. Note that conversion information indicating the conversion policy indicated in FIG. 6B is created in advance according to a computer simulation or the like and stored in the memory of the terminal device 2b.

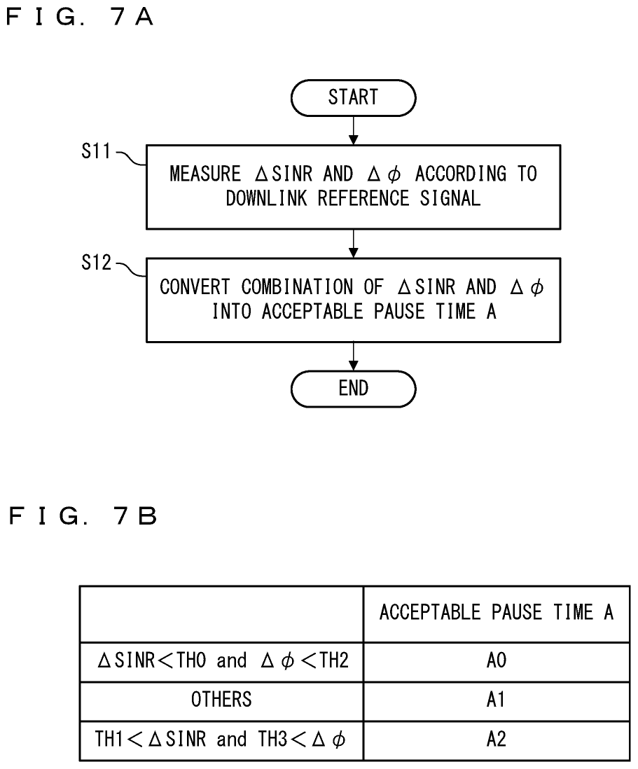

In the example depicted in FIGS. 7A and 7B, the terminal device 2b determines the acceptable pause time A according to a change in a SINR and a change in the phase of a channel estimate value that are calculated according to a reference signal. Accordingly, in S11 in the flowchart depicted in FIG. 7A, the terminal device 2b measures the amount of change in a SINR and the amount of change in the phase of a channel estimate value according to a downlink reference signal received from the base station 1. The amount of change in the phase of a channel estimate value may hereinafter be referred to as “Δϕ.” The phase of a channel estimate value may be measured using a publicly known technique such as multiplying a signal that is the complex conjugate of a known reference signal by the received reference signal.

In S12, the terminal device 2b converts the combination of ΔSINR and Δϕ into the acceptable pause time A. In this example, as depicted in FIG. 7B, ΔSINR is compared with specified thresholds TH0 and TH1, and Δϕ is compared with specified thresholds TH2 and TH3. “Acceptable pause time A=A0” is obtained when ΔSINR is smaller than the threshold TH0 and Δϕ is smaller than the threshold TH2. “Acceptable pause time A=A2” is obtained when ΔSINR is larger than the threshold TH1 and 4 is larger than the threshold TH3. In other cases, “acceptable pause time A=A1” is obtained. In this example, TH0<TH1, TH2<TH3, and A0>A1>A2 are satisfied. Thus, the acceptable pause time A is long when a change in the SINR is small and a change in the phase of the channel estimate value is small, and the acceptable pause time A is short when a change in the SINR is large and a change in the phase of the channel estimate value is large.

The conversion policy depicted in FIG. 7B is merely an example, and various variations are possible. For example, when the dependency on Δϕ is made small in comparison with ΔSINR the acceptable pause time A may be determined according to ΔSINR, and the value may be adjusted according to Δϕ. Alternatively, the acceptable pause time A may be determined according to Δϕ alone. Conversion information indicating a conversion policy is created in advance according to a computer simulation or the like and stored in the memory of the terminal device 2b.

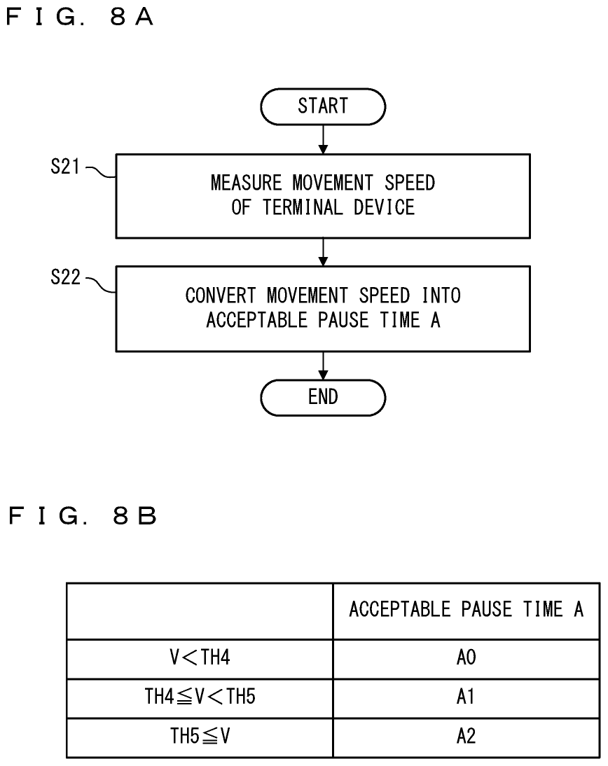

In the example depicted in FIGS. 8A and 8B, the terminal device 2b determines the acceptable pause time A according to the movement speed of the terminal device. Thus, in S21 in the flowchart depicted in FIG. 8A, the terminal device 2b measures the movement speed of the terminal device 2b. For example, the movement speed V of the terminal device 2b may be calculated using the global positioning system (GPS).

In S22, the terminal device 2b converts the movement speed V into the acceptable pause time A. In this example, the movement speed V is compared with specified thresholds TH4 and TH5, as depicted in FIG. 8B. “Acceptable pause time A=A0” is obtained when the movement speed V is less than the threshold TH4. “Acceptable pause time A=A1” is obtained when the movement speed V is greater than or equal to the threshold TH4 and less than the threshold TH5. “Acceptable pause time A=A2” is obtained when the movement speed V is greater than or equal to the threshold TH5. In this example, TH4<TH5 and A0>A1>A2 are satisfied. Thus, the lower the movement speed of the terminal device 2b is, the longer the acceptable pause time A is, and the higher the movement speed of the terminal device 2b is, the shorter the acceptable pause time A is. Conversion information indicating the conversion policy indicated in FIG. 8B is created in advance according to a computer simulation or the like and stored in the memory of the terminal device 2b.

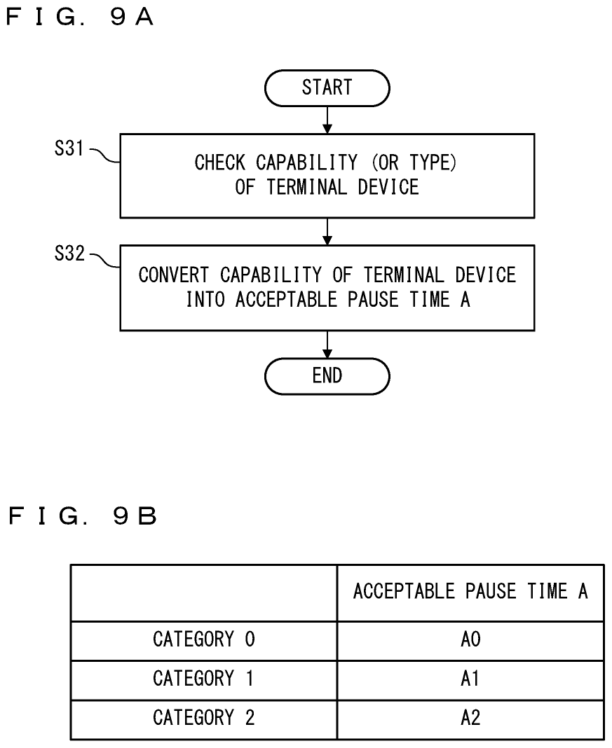

In the examples depicted in FIGS. 9A and 9B, the terminal device 2b determines the acceptable pause time A according to the capability (or type) of the terminal device. Thus, in S31 in the flowchart depicted in FIG. 9A, the terminal device 2b checks the capability of the terminal device 2b. Information indicating the capability of the terminal device 2b is recorded in advance in the memory of the terminal device 2b. For example, the capability of a terminal device may indicate the capability of a processor that processes a signal.

In S32, the terminal device 2b converts the capability of the terminal device 2b into the acceptable pause time A. In this example, the terminal device 2b belongs to one of categories 0-2, as depicted in FIG. 9B. “Acceptable pause time A=A0” is obtained when the terminal device 2b belongs to the category 0. “Acceptable pause time A=A1” is obtained when the terminal device 2b belongs to the category 1. “Acceptable pause time A=A2” is obtained when the terminal device 2b belongs to the category 2. Note that the capability of the category 0 is the highest, and the capability of the category 2 is the lowest. In this case, A0>A1>A2 is satisfied. Thus, the higher the capability of the terminal device 2b is, the longer the acceptable pause time A is, and the lower the capability of the terminal device 2b is, the shorter the acceptable pause time A is. Conversion information indicating the conversion policy indicated in FIG. 9B is stored in the memory of the terminal device 2b.

As described above, the acceptable pause time A is long when a change in the radio environment is small (or when the capability of a terminal device is high). In this case, the transmission restart instruction indicated in FIG. 5 is likely to be issued, and the probability with which the terminal device 2b performs a coding process and a modulation process again is low. Accordingly, the processing amount pertaining to the data transmission performed by the terminal device 2b is reduced. The acceptable pause time A is short when a change in the radio propagation environment is large (or when the capability of a terminal device is low). In this case, a coding process and a modulation process based on a newly determined MCS will be performed with a high probability. Thus, a data transmission using an inappropriate MSC will be avoided, and the communication quality will be improved.

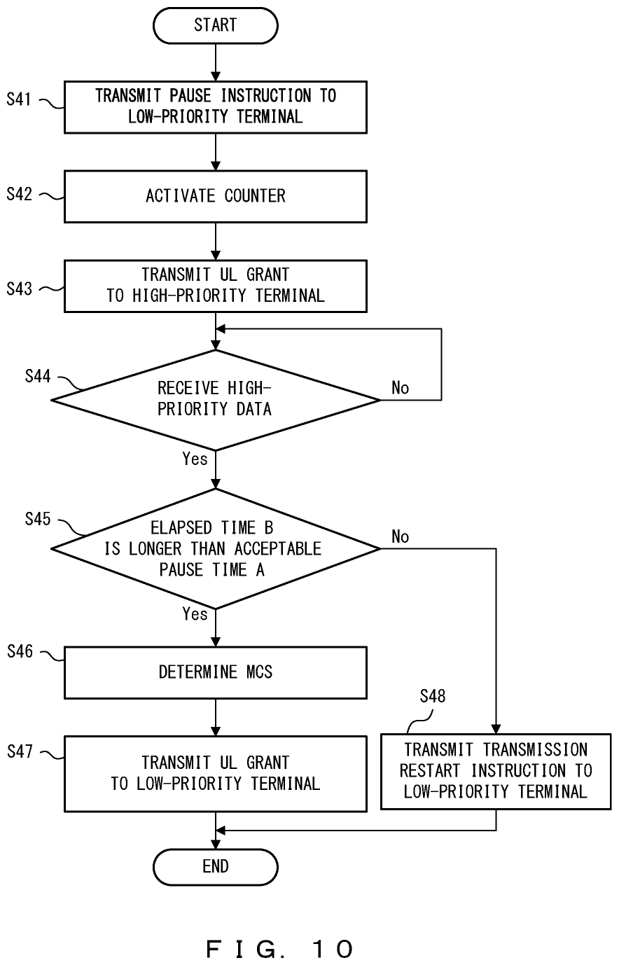

FIG. 10 is a flowchart illustrating an example of processes performed by the base station 1. The processes of this flowchart are performed when the base station 1 has received a scheduling request from the high-priority terminal. Assume that before receiving a scheduling request from the high-priority terminal, the base station 1 has given an UL grant to the low-priority terminal. In addition, it is assumed that the base station 1 knows the acceptable pause time A of the terminal device 2b.

In S41, the base station 1 transmits a pause instruction to the terminal device 2b. Upon receipt of the pause instruction, the terminal device 2b stops a data transmission process. In S42, the base station 1 activates a counter. In particular, the base station 1 counts an elapsed time B since the transmission of the pause instruction to the terminal device 2b. In S43, the base station 1 transmits an UL grant to the terminal device 2a. Upon receipt of the UL grant, the terminal device 2a starts a data transmission process.

In S44-S45, the base station 1 waits for high-priority data to be transmitted from the terminal device 2a. When receiving the high-priority data, the base station 1 decides whether the elapsed time B is longer than the acceptable pause time A.

When the elapsed time B is longer than the acceptable pause time A, the base station 1 determines that an MCS that the base station 1 reported at a past time to the terminal device 2b is inappropriate at present. In this case, in S46, the base station 1 newly determines an MCS for low-priority data to be transmitted from the terminal device 2b. In S47, the base station 1 transmits an UL grant to the terminal device 2b. This UL grant includes information indicating the new MCS determined in S46.

When the elapsed time B has reached the acceptable pause time A, the terminal device 2b discards a data signal stored in the transmission buffer memory. Afterward, upon receipt of the UL grant transmitted from the base station 1 in S47, the terminal device 2b generates a data signal by performing a coding process and a modulation process for low-priority data in accordance with the new MCS.

When the elapsed time B is shorter than the acceptable pause time A, the base station 1 determines that an MCS that the base station 1 reported at a past time to the terminal device 2b is still appropriate at present. In this case, in S48, the base station 1 transmits a transmission restart instruction to the terminal device 2b. In this case, the base station 1 does not need to newly determine an MCS for low-priority data to be transmitted from the terminal device 2b. Thus, the transmission restart instruction does not include information indicating a new MCS.

Before the elapsed time B reaches the acceptable pause time A, the terminal device 2b receives the transmission restart instruction transmitted from the base station 1 in S48. Thus, at this moment, a data signal has been stored in the transmission buffer memory of the terminal device 2b. Hence, the terminal device 2b does not need to perform a coding process and a modulation process for low-priority data again.

As described above, when an elapsed time B is longer than the acceptable pause time A, the base station 1 transmits an UL grant to the low-priority terminal. When an elapsed time B is shorter than the acceptable pause time A, the base station 1 transmits a transmission restart instruction to the low-priority terminal.

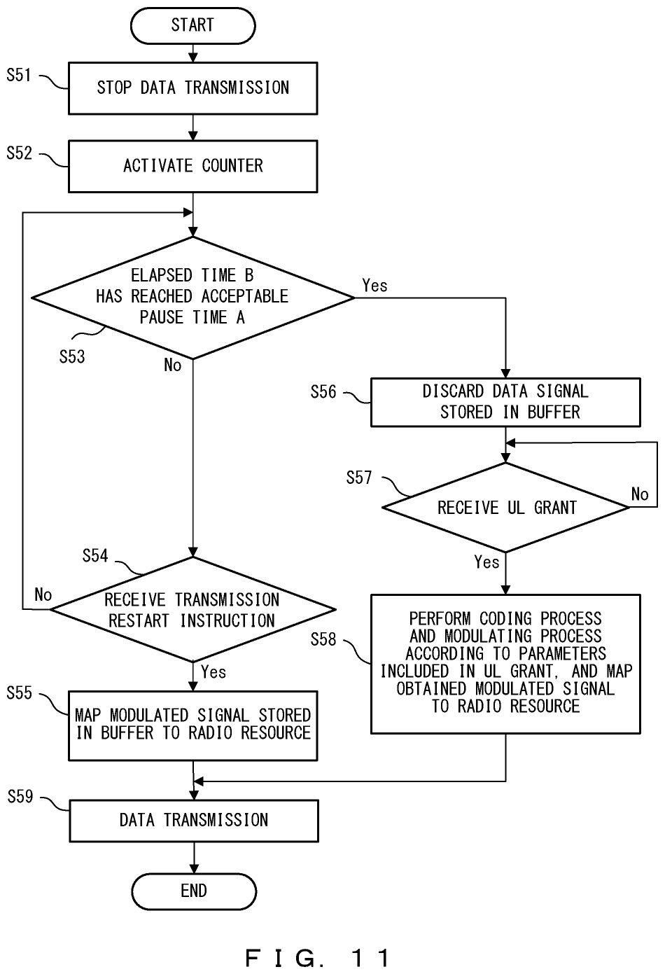

FIG. 11 is a flowchart illustrating an example of processes performed by a terminal device. The processes of this flowchart are performed by the low-priority terminal (i.e., terminal device 2b). In particular, these processes are performed when the terminal device 2b has received a pause instruction from the base station 1.

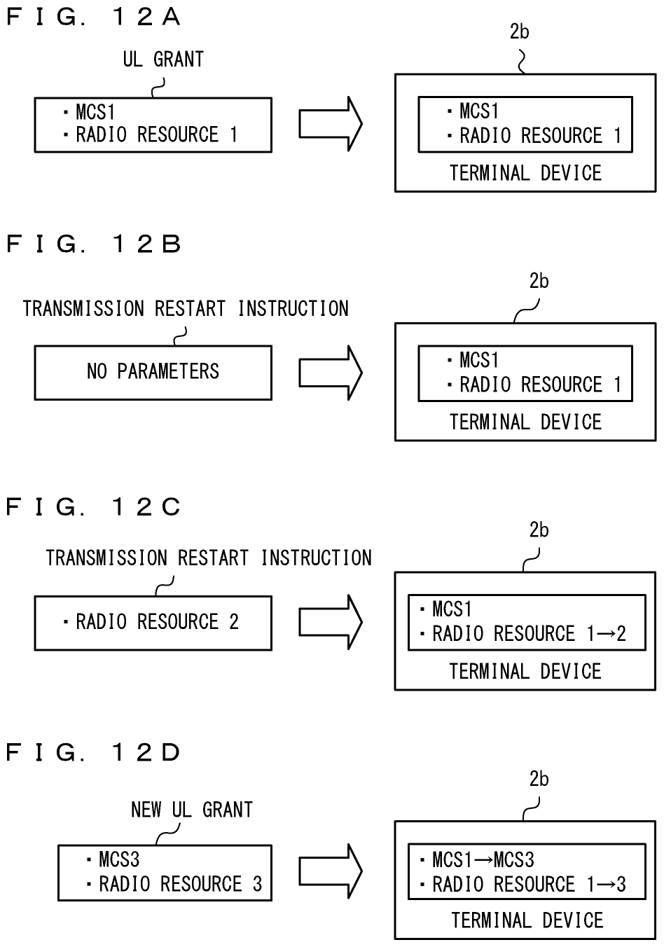

Before receiving the pause instruction, the terminal device 2b has received an UL grant from the base station 1. The UL grant is generated by the base station 1 in accordance with a scheduling request and includes some parameters as transmission control information. For example, as depicted in FIG. 12A, the UL grant may include information indicating a radio resource and an MCS for transmitting low-priority data from the terminal device 2b (radio resource 1, MCS 1). The terminal device 2b stores these parameters in the memory within the device. The terminal device 2b generates a data signal by performing a coding process and a modulation process for low-priority data according to these parameters. That is, a data signal is generated according to the MSC 1. The generated data signal is stored in the transmission buffer memory of the terminal device 2b. However, when the terminal device 2b has received a pause instruction, the terminal device 2b may not have generated a data signal yet.

Upon receipt of a pause instruction from the base station 1, the terminal device 2b stops a data transmission process in S51. In this case, when a data signal has already been generated, this data signal is stored in the transmission buffer memory. In S52, the terminal device 2b activates a counter. In particular, the terminal device 2b starts to count an elapsed time B since the reception of the pause instruction.

In S53-S54, the terminal device 2b waits for a transmission restart instruction while monitoring the elapsed time B. The transmission restart instruction is generated by the base station 1 in S48 in the flowchart depicted in FIG. 10. When receiving a transmission restart instruction before the elapsed time B reaches the acceptable pause time A, the terminal device 2b maps, in S55, a data signal stored in the transmission buffer memory to a radio resource allocated to low-priority data to be transmitted. When a data signal is not stored in the transmission buffer memory, the terminal device 2b generates a data signal by performing a coding process and a modulation process in accordance with parameters reported at a past time. Then, the data signal is mapped to a radio resource.

When an elapsed time B has reached the acceptable pause time A before a transmission restart instruction is received, the terminal device 2b discards the data signal stored in the transmission buffer memory in S56. In particular, the terminal device 2b discards a data signal generated in accordance with parameters reported at a past time. Then, the terminal device 2b waits for an UL grant in S57. The UL grant is generated by the base station 1 in S46-S47 in the flowchart depicted in FIG. 10.

Upon receipt of an UL grant, the terminal device 2b performs the process of S58. In particular, the terminal device 2b generates a data signal by performing a coding process and a modulation process for low-priority data according to parameters included in the received UL grant. The terminal device 2b maps the data signal to a radio resource.

When S55 or S58 is finished, the terminal device 2b performs a data transmission in S59. In particular, when a transmission restart instruction is received before the elapsed time B reaches the acceptable pause time A, the terminal device 2b performs a data transmission based on parameters reported in response to a scheduling request at a past time. When a new UL grant is received after the elapsed time B has reached the acceptable pause time A, the terminal device 2b performs a data transmission based on newly reported parameters.

For example, as depicted in FIG. 12B, a transmission restart instruction may include no parameters for transmitting low-priority data. In this case, the terminal device 2b performs a data transmission based on parameters reported at a past time in response to a scheduling request (MCS 1 and radio resource 1). Thus, the coding process and the modulation process are performed according to the MCS 1, and mapping is performed according to the radio resource 1.

However, a transmission restart instruction may include a parameter for transmitting low-priority data. In the example depicted in FIG. 12C, the transmission restart instruction includes information indicating a radio resource that the base station 1 has newly allocated to low-priority data. In this case, the terminal device 2b performs a data transmission based on both a parameter stored in the memory that was reported at a past time and the newly reported parameter. In this example, a new MCS is not reported by the transmission restart instruction. Thus, the value stored in the memory (i.e., MCS 1) is used for the MCS. Meanwhile, a new radio resource is reported by the transmission restart instruction. Thus, the newly reported value (i.e., radio resource 2) is used for the radio resource. Accordingly, in this case, a coding process and a modulation process are performed according to the MCS 1, and mapping is performed according to the radio resource 2. For example, the radio resources 1 and 2 may each have a different frequency allocated to a data transmission.

A new UL grant includes information indicating, as parameters, a radio resource and an MCS. However, the parameters included in the new UL grant are not the same as those reported in response to a scheduling request. In the example depicted in FIG. 12D, the new UL grant includes an “MCS 3” and a “radio resource 3.” The terminal device 2b performs a data transmission based on the newly reported parameters. In particular, a coding process and a modulation process are performed according to the MCS 3, and mapping is performed according to the radio resource 3. For example, the radio resources 1 and 3 may each have a different frequency allocated to a data transmission.

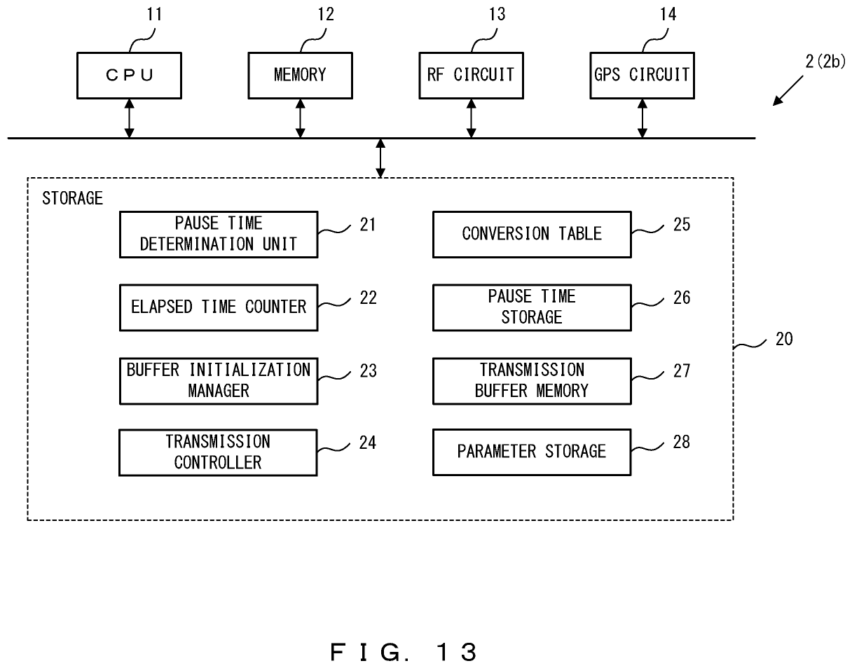

FIG. 13 illustrates an example of a terminal device 2 used in the first embodiment. This terminal device 2 corresponds to the terminal device 2b that transmits low-priority data in the examples depicted in FIGS. 4-5.

As depicted in FIG. 13, the terminal device 2 includes a CPU 11, a memory 12, an RF circuit 13, a GPS circuit 14, and a storage 20. The CPU 11 executes a program stored in the storage 20. The memory 12 is used as a work area for the CPU 11. The RF circuit 13 transmits/receives an RF signal to/from the base station 1. The GPS circuit 14 detects the position of the terminal device 2. The terminal device 2 may include other elements or circuits that are not depicted in FIG. 13.

The storage 20 includes a pause time determination unit 21, an elapsed time counter 22, a buffer initialization manager 23, a transmission controller 24, a conversion table 25, a pause time storage 26, a transmission buffer memory 27, and a parameter storage 28. The storage 20 may include other elements that are not depicted in FIG. 13.

The pause time determination unit 21 determines the acceptable pause time A depicted in FIGS. 4-5. In the examples depicted in FIGS. 6A-7B, the pause time determination unit 21 determines the acceptable pause time A according to the quality of wireless communication between the terminal device 2 and the base station 1. In the example depicted in FIGS. 8A and 8B, the pause time determination unit 21 determines the acceptable pause time A according to the movement speed of the terminal device 2. In the example depicted in FIGS. 9A and 9B, the pause time determination unit 21 determines the acceptable pause time A according to the capability (or type) of the terminal device 2.

The elapsed time counter 22 counts an elapsed time B since the terminal device 2 receiving a pause instruction from the base station 1. When the elapsed time B has reached the acceptable pause time A, the buffer initialization manager 23 initializes the transmission buffer memory 27. That is, a data signal stored in the transmission buffer memory 27 is discarded.

The transmission controller 24 generates a data signal from transmission data according to communication parameters stored in the parameter storage 28. The transmission controller 24 maps the generated data signal to a designated radio resource. The mapped data signal is transmitted by the RF circuit 13.

When the terminal device 2 has received a transmission restart instruction from the base station 1 before the elapsed time B reaches the acceptable pause time A, the transmission controller 24 will perform an uplink transmission using a data signal stored in the transmission buffer memory 27. When the terminal device 2 has received a new UL grant from the base station 1 after the elapsed time B reached the acceptable pause time A, the transmission controller 24 will generate a data signal from transmission data according to communication parameters included in the new UL grant. At this time, the data signal that was stored in the transmission buffer memory 27 has already been discarded. The transmission controller 24 performs an uplink transmission using the newly generated data signal.

The conversion table 25 stores information for converting a radio quality, the movement speed of the terminal device 2, the capability or type of the terminal device 2 into the acceptable pause time A. The conversion table 25 is referred to by the pause time determination unit 21. The pause time storage 26 stores the value of the acceptable pause time A determined by the pause time determination unit 21. The transmission buffer memory 27 stores a data signal generated by the transmission controller 24. The parameter storage 28 stores communication parameters reported from the base station 1. The communication parameters include information indicating a modulation scheme, information indicating a coding scheme, and information indicating a radio resource allocated to transmission data.

The pause time determination unit 21, the buffer discard manager 23, and the transmission controller 24 are implemented by programs describing the above-described functions. Thus, the functions of the pause time determination unit 21, the buffer discard manager 23, and the transmission controller 24 are provided by the CPU 11 executing the programs.

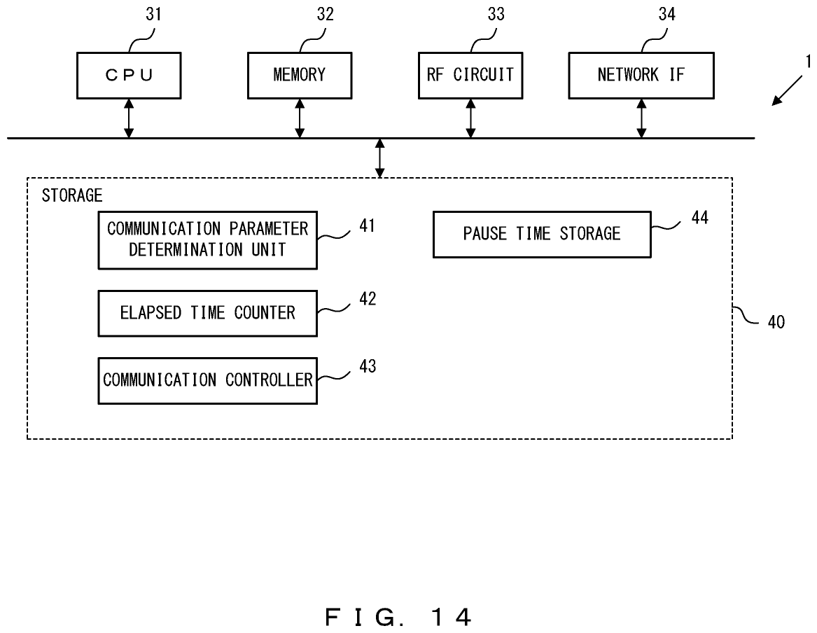

FIG. 14 illustrates an example of the base station 1 used in the first embodiment. As depicted in FIG. 14, the base station 1 includes a CPU 31, a memory 32, an RF circuit 33, a network interface 34, and a storage 40. The CPU 31 executes a program stored in the storage 40. The memory 32 is used as a work area for the CPU 31. The RF circuit 33 transmits/receives an RF signal to/from a terminal device 2. The network interface 34 provides an interface for connecting to another network. The base station 1 may include other elements or circuits that are not depicted in FIG. 14.

The storage 40 includes a communication parameter determination unit 41, an elapsed time counter 42, a communication controller 43, and a pause time storage 44. The storage 40 may include other elements that are not depicted in FIG. 14.

When the base station 1 has received a scheduling request from a terminal device 2, the communication parameter determination unit 41 will determine communication parameters for uplink communication to be performed by the terminal device 2. When the base station 1 has received high-priority data from a high-priority terminal after an elapsed time B reached the acceptable pause time A, the communication parameter determination unit 41 will determine new communication parameters for uplink communication to be performed by the terminal device 2. The communication parameters include information indicating a modulation scheme, information indicating a coding scheme, and information indicating a radio resource to be allocated to the terminal device 2.

The elapsed time counter 42 counts an elapsed time B since the transmission of a pause instruction from the base station 1 to a terminal device 2. A time at which the base station 1 transmits a pause instruction to the terminal device 2 is substantially the same as a time at which the terminal device 2 receives the pause instruction from the base station 1. Thus, the elapsed time B counted by the base station 1 and the elapsed time B counted by the terminal device 2 are synchronous with each other.

When accepting a scheduling request received from a terminal device 2, the communication controller 43 generates and transmits an UL grant to the terminal device 2. The UL grant may include communication parameters determined by the communication parameter determination unit 41. When a scheduling request is received from a high-priority terminal that has a higher priority than the terminal device 2 (e.g., received from the terminal device 2a in FIGS. 4-5), the communication controller 43 will transmit a pause instruction to the terminal device 2.

When the base station 1 has received high-priority data from the high-priority terminal before the elapsed time B reaches the acceptable pause time A, the communication controller 43 will transmit a transmission restart instruction to the terminal device 2. When the base station 1 has received high-priority data from the high-priority terminal after the elapsed time B reached the acceptable pause time A, the communication controller 43 will generate and transmit a new UL grant to the terminal device 2. In this case, the UL grant may include communication parameters newly determined by the communication parameter determination unit 41.

The pause time storage 26 stores the value of the acceptable pause time A reported from a terminal device 2.

The communication parameter determination unit 41 and the communication controller 43 are implemented by programs describing the above-described functions. Thus, the functions of the communication parameter determination unit 41 and the communication controller 43 are provided by the CPU 31 executing the programs.

### Second Embodiment

In the first embodiment, a terminal device 2 determines the acceptable pause time A. By contrast, in the second embodiment, the base station 1 determines the acceptable pause time A.

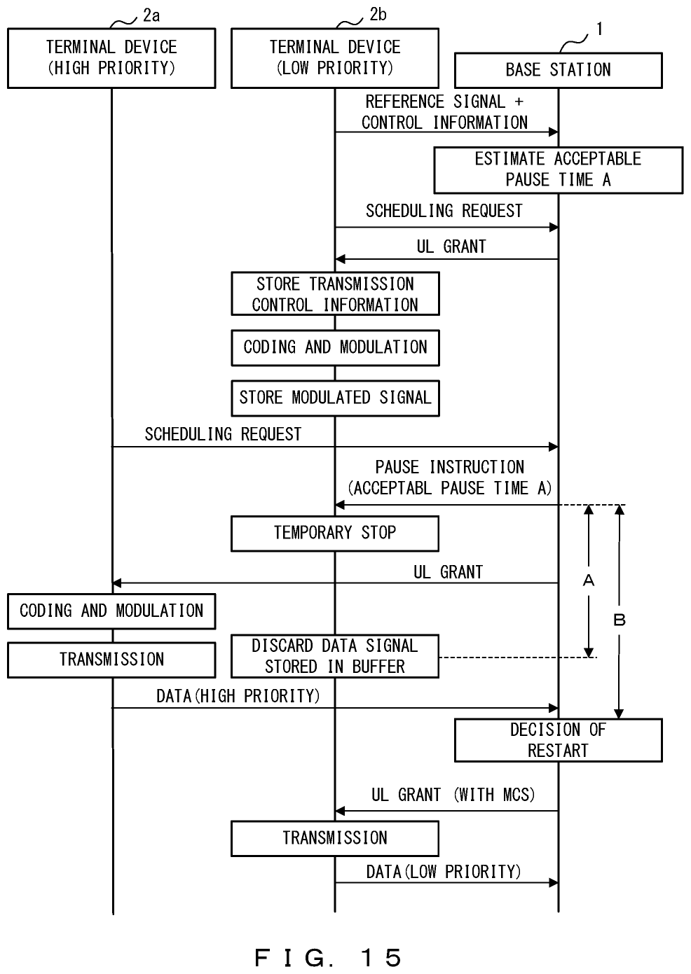

FIG. 15 illustrates an example of priority control for an uplink in the second embodiment. In the second embodiment, the base station 1 determines the acceptable pause time A according to the quality of wireless communication between the base station 1 and the terminal device 2b. In this case, according to a reference signal transmitted from the terminal device 2b, the base station 1 determines the acceptable pause time A by using either of the methods indicated in FIGS. 6A-7B. The base station 1 may determine the acceptable pause time A in accordance with the movement speed of the terminal device 2b. In this case, the base station 1 receives control information indicating the movement speed of the terminal device 2b from the terminal device 2b. Then, the base station 1 determines the acceptable pause time A by using the method indicated in FIGS. 8A and 8B. Alternatively, the base station 1 may determine the acceptable pause time A in accordance with the capability or type of the terminal device 2b. In this case, the base station 1 receives control information indicating the capability or type of the terminal device 2b from the terminal device 2b. Then, the base station 1 determines the acceptable pause time A by using the method indicated in FIGS. 9A and 9B.

The subsequent priority control sequence in FIG. 15 is substantially the same as that in FIG. 4. However, in the second embodiment, the acceptable pause time A is reported from the base station 1 to the terminal device 2b by using a pause instruction. In FIG. 15, the base station 1 receives high-priority data from the terminal device 2a (i.e., a high-priority terminal) after the elapsed time B reaches the acceptable pause time A. Accordingly, the base station 1 will transmit an UL grant including information indicating an MCS to the terminal device 2b.

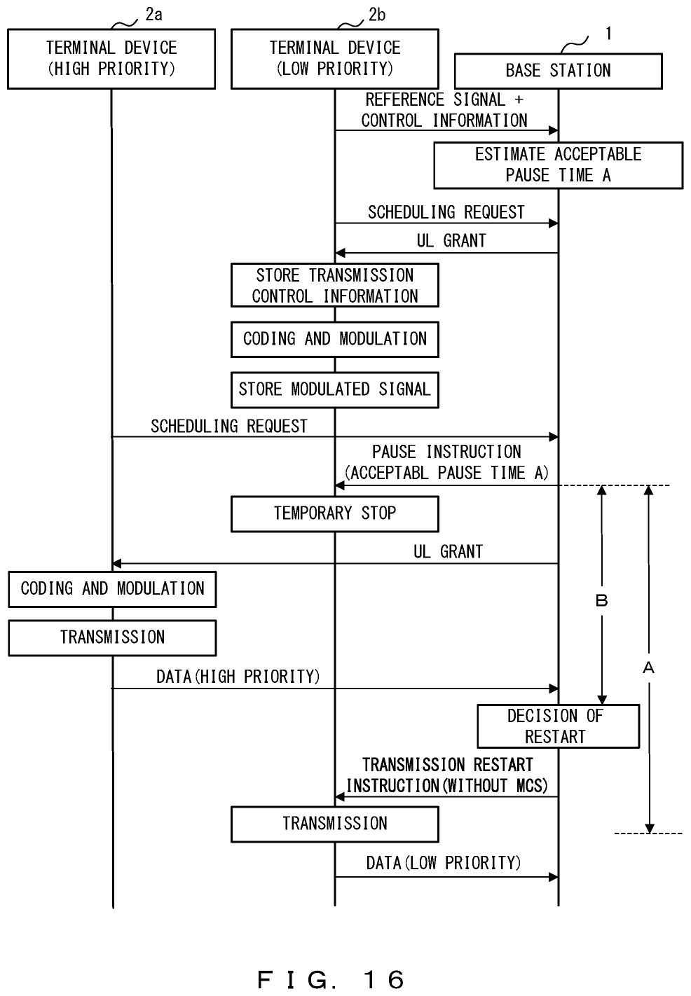

FIG. 16 illustrates another example of priority control for an uplink in the second embodiment. Note that the method used by the base station 1 in FIG. 16 to determine the acceptable pause time A is substantially the same as that in FIG. 15. The priority control sequence in FIG. 16 is substantially the same as that in FIG. 5. However, in the second embodiment, the acceptable pause time A is reported from the base station 1 to the terminal device 2b by using a pause instruction, as in the case depicted in FIG. 15. In FIG. 16, the base station 1 receives high-priority data from the terminal device 2a (i.e., a high-priority terminal) before the elapsed time B reaches the acceptable pause time A. Accordingly, the base station 1 will transmit a transmission restart instruction to the terminal device 2b.

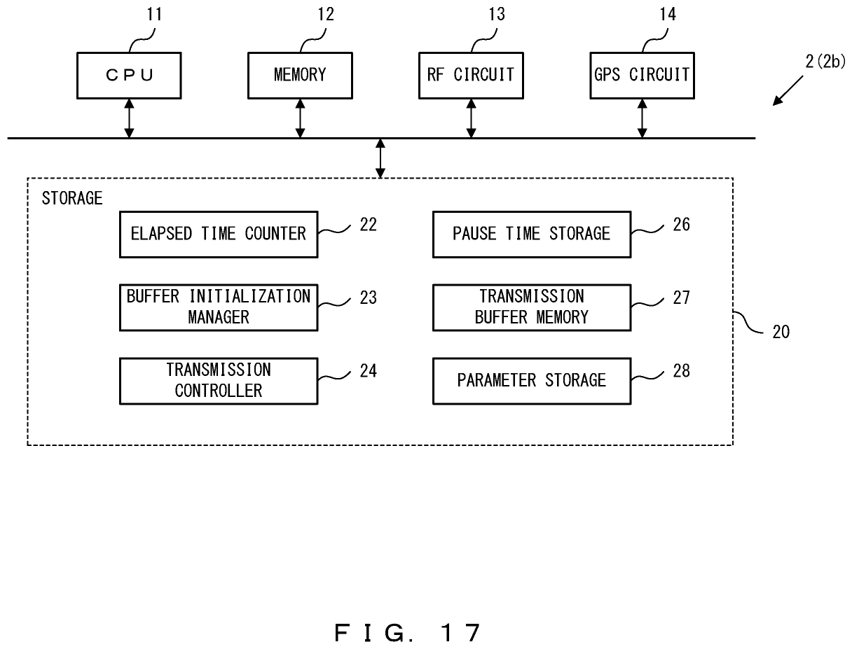

FIG. 17 illustrates an example of a terminal device used in the second embodiment. The configuration of the terminal device 2 in the second embodiment is substantially the same as that in the first embodiment. However, in the second embodiment, the base station 1 determines the acceptable pause time A. Thus, the terminal device 2 in the second embodiment may not include the pause time determination unit 21 and the conversion table 25, as depicted in FIG. 17.

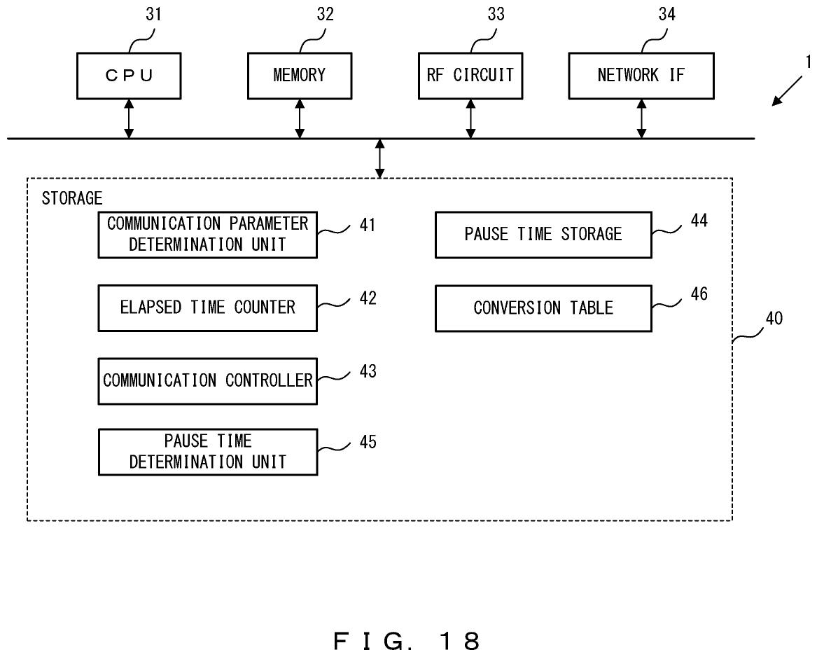

FIG. 18 illustrates an example of the base station used in the second embodiment. The configuration of the base station 1 in the second embodiment is substantially the same as that in the first embodiment. However, in the second embodiment, the base station 1 determines the acceptable pause time A. Thus, the base station 1 in the second embodiment includes a pause time determination unit 45 and a conversion table 46, as depicted in FIG. 18. The pause time determination unit 45 and the conversion table 46 are substantially the same as the pause time determination unit 21 and the conversion table 25 of the terminal device 2 depicted in FIG. 13.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A terminal device used in a wireless communication system that includes a base station, the terminal device comprising
a processor configured to
determine a value pertaining to a stop time of a transmission process,
count, when the terminal device receives a first signal indicating a grant of an uplink transmission from the base station and then receives a second signal indicating an instruction to stop the uplink transmission granted by the first signal from the base station, an elapsed time since the reception of the second signal,
perform the uplink transmission based on the grant indicated by the first signal when the terminal device receives a third signal indicating a restart of the uplink transmission from the base station before the elapsed time reaches the determined value, and
perform the uplink transmission based on a grant indicated by a fourth signal when the terminal device receives the fourth signal from the base station after the elapsed time reaches the determined value, the fourth signal indicating a grant of the uplink transmission.

2. The terminal device according to claim 1, wherein
the processor reports the value pertaining to the stop time of the transmission process to the base station.

3. The terminal device according to claim 1, wherein
the first signal includes information indicating a modulation scheme, information indicating a coding scheme, and information indicating a radio resource,
when the terminal device receives the first signal, the processor generates a data signal from transmission data according to the information included in the first signal and stores the generated data signal in a memory, and
when the terminal device receives the third signal before the elapsed time reaches the value, the processor performs the uplink transmission by using a data signal stored in the memory.

4. The terminal device according to claim 3, wherein
the third signal does not include at least one of the information indicating a modulation scheme, the information indicating a coding scheme, and the information indicating a radio resource, and
when the terminal device receives the third signal before the elapsed time reaches the value, the processor performs the uplink transmission by using a data signal stored in the memory according to the information included in the third signal.

5. The terminal device according to claim 1, wherein
the first signal includes information indicating a modulation scheme, information indicating a coding scheme, and information indicating a radio resource,
when the terminal device receives the first signal, the processor generates a data signal from transmission data according to the information included in the first signal and stores the generated data signal in a memory, and
when the terminal device receives the fourth signal after the elapsed time reached the value, the processor performs the uplink transmission without using a data signal stored in the memory.

6. The terminal device according to claim 5, wherein
the fourth signal includes information indicating a modulation scheme, information indicating a coding scheme, or information indicating a radio resource, and
when the terminal device receives the fourth signal after the elapsed time reached the value, the processor generates a data signal from the transmission data according to the information included in the fourth signal so as to perform the uplink transmission.

7. The terminal device according to claim 1, wherein
the processor determines the value according to a quality of wireless communication between the terminal device and the base station.

8. The terminal device according to claim 1, wherein
the processor determines the value according to a movement speed of the terminal device.

9. The terminal device according to claim 1, wherein
the processor determines the value according to a capability or a type of the terminal device.

10. A base station device used in a wireless communication system that includes a terminal device, the base station device comprising:
a storage configured to store a value pertaining to a stop time of a transmission process performed by the terminal device, the value being reported from the terminal device;
a counter configured to count, when the base station device transmits a first signal indicating a grant of an uplink transmission to the terminal device and then transmits a second signal to the terminal device in response to a request received from a high-priority terminal having a higher priority than the terminal device, an elapsed time since the transmission of the second signal, the second signal indicating an instruction to stop the uplink transmission granted by the first signal; and
a processor configured to
transmit a third signal indicating a restart of the uplink transmission to the terminal device when the base station device receives an uplink signal from the high-priority terminal before the elapsed time reaches the stored value, and
transmit a fourth signal indicating a grant of the uplink transmission to the terminal device when the base station device receives an uplink signal from the high-priority terminal after the elapsed time reaches the stored value.

11. The base station device according to claim 10, wherein
when the base station device receives a request for an uplink radio resource from the terminal device, the processor determines a communication parameter for an uplink transmission to be performed by the terminal device and reports the determined communication parameter to the terminal device, and
when the base station device receives the request from the high-priority terminal after the elapsed time reaches the value, the processor redetermines a communication parameter for an uplink transmission to be performed by the terminal device and reports the redetermined communication parameter to the terminal device.

12. A terminal device used in a wireless communication system that includes a base station, the terminal device comprising:
a storage configured to store a value pertaining to a stop time of a transmission process performed by the terminal device, the value being reported from the base station; and
a processor configured to
count, when the terminal device receives a first signal indicating a grant of an uplink transmission from the base station and then receives a second signal indicating an instruction to stop the uplink transmission granted by the first signal from the base station, an elapsed time since the reception of the second signal,
perform the uplink transmission based on the grant indicated by the first signal when the terminal device receives a third signal indicating a restart of the uplink transmission from the base station before the elapsed time reaches the stored value, and
perform the uplink transmission based on a grant indicated by a fourth signal when the terminal device receives the fourth signal from the base station after the elapsed time reaches the stored value, the fourth signal indicating a grant of the uplink transmission.

13. Abase station device used in a wireless communication system that includes a terminal device, the base station device comprising
a processor configured to
determine a value pertaining to a stop time of a transmission process performed by the terminal device,
count, when the base station device transmits a first signal indicating a grant of an uplink transmission to the terminal device and then transmits a second signal to the terminal device in response to a request received from a high-priority terminal having a higher priority than the terminal device, an elapsed time since the transmission of the second signal, the second signal indicating an instruction to stop the uplink transmission granted by the first signal; and
transmit a third signal indicating a restart of the uplink transmission to the terminal device when the base station device receives an uplink signal from the high-priority terminal before the elapsed time reaches the determined value, and
transmit a fourth signal indicating a grant of the uplink transmission to the terminal device when the base station device receives an uplink signal from the high-priority terminal after the elapsed time reaches the determined value.

14. A wireless communication system comprising a base station and a terminal device, wherein
the terminal device determines a value pertaining to a stop time of a transmission process performed by the terminal device and reports the determined value to the base station,
the terminal device starts a process of an uplink transmission when receiving a first signal indicating a grant of the uplink transmission from the base station,
the base station starts to count, when the base station transmits a second signal to the terminal device in response to a request received from a high-priority terminal having a higher priority than the terminal device, an elapsed time since the transmission of the second signal, the second signal indicating an instruction to stop the uplink transmission granted by the first signal,
when receiving the second signal from the base station, the terminal device stops the process of the uplink transmission and starts to count the elapsed time since the reception of the second signal,
the base station transmits a third signal indicating a restart of the uplink transmission to the terminal device when the base station receives an uplink signal from the high-priority terminal before the elapsed time counted by the base station reaches the determined value,
the base station transmits a fourth signal indicating a grant of the uplink transmission to the terminal device when the base station receives an uplink signal from the high-priority terminal after the elapsed time counted by the base station reaches the determined value,
the terminal device restarts the process of the uplink transmission that has been stopped in response to the second request, when the terminal device receives the third signal before the elapsed time counted by the terminal device reaches the determined value, and
the terminal device performs the uplink transmission according to the grant indicated by the fourth signal when the terminal device receives the fourth signal after the elapsed time counted by the terminal device reaches the determined value.

15. A wireless communication method implemented by a first wireless device and a second wireless device, wherein
the first wireless device transmits a first signal to the second wireless device, the first signal including a value pertaining to a stop time of a transmission process performed by the first wireless device,
when the second wireless device transmits a second signal to the first wireless device and then transmits a third signal to the first wireless device, the second wireless device starts to count an elapsed time since the transmission of the third signal, the second signal indicating a transmission grant, the third signal indicating an instruction to stop a transmission process pertaining to the transmission grant,
the second wireless device transmits a fourth signal indicating an instruction to restart the transmission process to the first wireless device when the elapsed time is shorter than the value at a moment at which the first wireless device becomes capable of performing a transmission; and
the second wireless device transmits a fifth signal indicating a new transmission grant to the first wireless device when the elapsed time is longer than the value at a moment at which the first wireless device becomes capable of performing a transmission.
